(19) United States
(12) Patent Application Publication
(10) Pub. No.: US 2010/0167082 A1
(43) Pub. Date: Jul. 1, 2010

(54) PAPER FOR PREVENTING OUTFLOW OF DOCUMENT AND METHOD FOR MANUFACTURING THEREOF

(76) Inventor: Won-Sik Oh, Seongnam-si (KR)

Correspondence Address: LEXYOUME IP GROUP, LLC, 5180 PARKSTONE DRIVE, SUITE 175, CHANTILLY, VA, 20151, US

(21) Appl. No.: 12/663,542

(22) PCT Filed: Jun. 5, 2008
(86) PCT No.: PCT/KR2008/003185

§ 371 Date: Dec. 8, 2009

(30) Foreign Application Priority Data
Jun. 8, 2007 (KR) 10-2007-0056115
Jan. 9, 2008 (KR) 10-2008-0002765

(51) Int. Cl. B32B 29/00; B32B 15/12; B32B 15/00; B32B 37/00; B32B 38/14; B32B 37/02

(52) U.S. Cl. 428/608; 428/537.5; 428/464; 428/457; 156/60; 156/277; 156/235

(57) ABSTRACT

The present invention relates to printing paper for security and a method of producing the same. According to the printing paper for security of the present invention, a white printing layer and a black printing layer are sequentially printed on a side of a first raw paper sheet and the white printing layer and a black printing layer are sequentially printed on a side of a second raw paper sheet. In addition, while a tag for detection that includes a magnetic material is provided between the black printing layer of the first raw paper sheet and the black printing layer of the second raw paper sheet, the first raw paper sheet and the second raw paper sheet are laminated. According to the present invention, since the tag for detection is not exposed to the outside of the printing paper, intentional damage to the tag for detection can be prevented.

### TECHNICAL FIELD

The present invention relates to printing paper. More particularly, the present invention relates to printing paper for security for preventing outflow of a document and product theft and a method of producing the same.

### BACKGROUND ART

Currently, in accordance with an increase in the importance of security, security technology that controls the outflow of various storage media has been developed. Moreover, with respect to printed documents, the necessity for controlling the outflow of the media is growing. Thus, an attempt in which a tag for detection is attached to documents for security to prevent the outflow has increased.

That is, a detection gate is provided at an exit, and when the document to which the tag for detection is attached passes through the detection gate, this is detected and the outflow is prohibited. Currently, this technology is used to prevent the outflow of various books or documents without notice in libraries or companies.

Here, the detection manner of a tag for detection is classified as an electromagnetic (EM) manner in which, when a tag for detection comprising a metal material having the soft magnetic property passes through an AC magnetic field that is generated in a detection means such as a detection gate, a change in magnetic field occurs and the existence of the tag for detection is detected by the change in magnetic field, and a radio frequency (RF) manner in which, after intrinsic discernment information is inputted into a very small IC chip, an object to which this chip is attached is recognized, traced, and managed by the radio frequency.

Particularly, in the case in which printed objects are managed, since the volume and the thickness thereof are small, the electromagnetic type of detection tag in which the attachment is easily performed and the attachment position is not easily exposed is frequently used.

Meanwhile, Japanese Patent Laid-Open Publication No. 2002-317398 and Japanese Patent Laid-Open Publication No. 2007-169837 disclose a technology in which a tag for detection is not separately attached to a document but a magnetic material is inserted into paper to prevent the outflow of the document without notice. That is, according to the document, while the tag for detection (magnetic wire) that comprises a magnetic material is interposed between two raw paper sheets, the two raw paper sheets are laminated to produce desired paper.

However, according to the technology disclosed in the document, there is a problem in that since the tag for detection (magnetic wire) that comprises a magnetic material is included in the paper cannot be concealed, in the case of thin paper such as office paper, the tag for detection is easily seen from the outside, and thus a reduction in security such as intentional damage to the tag for detection occurs.

### DETAILED DESCRIPTION

### Technical Problem

Therefore, the present invention has been made keeping in mind the problems occurring in the related art, and an object of the present invention is to provide printing paper for security that includes a tag for detection comprising a magnetic material that is not easily seen from the outside and has excellent security, and a method of producing the same.

### Technical Solution

According to an exemplary embodiment of the present invention, to accomplish the above object, printing paper for security includes: a first raw paper sheet and a second raw paper sheet; a first hiding layer that is formed on a side of the first raw paper sheet; a second hiding layer that is formed on a side of the second raw paper sheet; and at least one tag for detection that is formed between the first hiding layer and the second hiding layer and includes a magnetic material.

In addition, according to another exemplary embodiment of the present invention, printing paper for security includes: a first raw paper sheet and a second raw paper sheet; a metal thin film that is formed on a side of the second raw paper sheet; and at least one tag for detection that is formed between the metal thin film and a side of the first raw paper sheet and includes a magnetic material.

According to another exemplary embodiment of the present invention, printing paper for security includes: a first raw paper sheet and a second raw paper sheet; a first printing layer and a second printing layer that are sequentially printed on a side of the first raw paper sheet; a third printing layer and a fourth printing layer that are sequentially printed on a side of the second raw paper sheet; and at least one tag for detection that is formed between the second printing layer and the fourth printing layer and includes a magnetic material.

According to another exemplary embodiment of the present invention, printing paper for security includes: a first raw paper sheet and a second raw paper sheet; at least one tag for detection that is formed between the first raw paper sheet and the second raw paper sheet and includes a magnetic material; and a hiding layer that is formed between the first raw paper sheet and the tag for detection.

According to another exemplary embodiment of the present invention, printing paper for security includes: a first raw paper sheet and a second raw paper sheet; at least one tag for detection that is formed between the first raw paper sheet and the second raw paper sheet and includes a magnetic material; and a first printing layer and a second printing layer that are sequentially printed between the first raw paper sheet and the tag for detection.

According to an exemplary embodiment of the present invention, a method of producing printing paper for security includes: forming a first hiding layer on a side of a first raw paper sheet; forming a second hiding layer on a side of a second raw paper sheet; and laminating the first raw paper sheet and the second raw paper sheet while a tag for detection including a magnetic material is provided between the first hiding layer and the second hiding layer.

According to another exemplary embodiment of the present invention, a method of producing printing paper for security includes: attaching a tag for detection including a magnetic material on a side of a first raw paper sheet; forming a metal thin film on a side of a second raw paper sheet; and laminating a side of the first raw paper sheet and a side of the second raw paper sheet so that the tag for detection and the metal thin film are in contact.

Meanwhile, according to another exemplary embodiment of the present invention, a method of producing printing paper for security includes: sequentially printing a first printing layer and a second printing layer on a side of a first raw paper sheet; sequentially printing a third printing layer and a fourth printing layer on a side of a second raw paper sheet; and laminating the first raw paper sheet and the second raw paper sheet while at least one tag for detection including a magnetic material is provided between the second printing layer and the fourth printing layer.

### Advantageous Effects

According to the present invention, since the tag for detection is not exposed to the outside of the printing paper, intentional damage to the tag for detection can be prevented.

### BRIEF DESCRIPTION OF THE DRAWINGS

FIG. 1 is a perspective view of printing paper for security according to a specific exemplary embodiment of the present invention.

FIG. 2 is a cross-sectional view of printing paper for security according to the first exemplary embodiment of the present invention.

FIG. 3 is a cross-sectional view of printing paper for security according to the second exemplary embodiment of the present invention.

FIG. 4 is a cross-sectional view of printing paper for security according to the third exemplary embodiment of the present invention.

FIG. 5 is a flowchart that illustrates a method of producing the printing paper for security according to the first exemplary embodiment of the present invention.

FIG. 6 is a flowchart that illustrates a method of producing the printing paper for security according to the second exemplary embodiment of the present invention.

FIG. 7 is a flowchart that illustrates a method of producing the printing paper for security according to the third exemplary embodiment of the present invention.

### BEST MODE

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the specification, unless explicitly described to the contrary, the word “comprise” and variations such as “comprises” or “comprising” will be understood to imply the inclusion of stated elements but not the exclusion of any other elements.

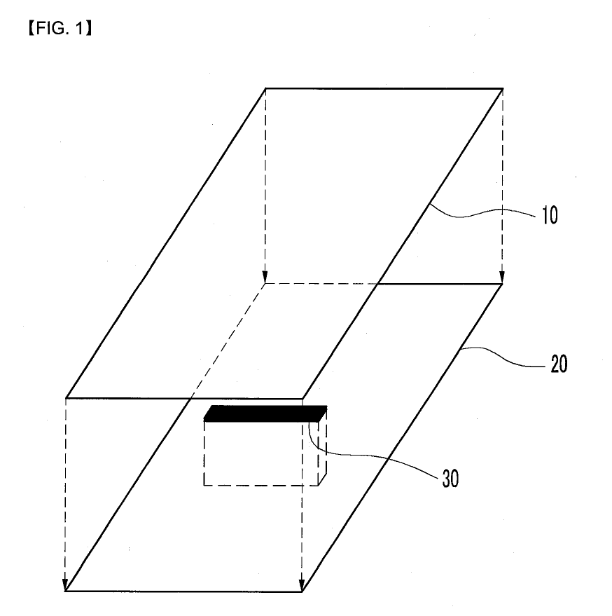

FIG. 1 is a perspective view that illustrates configuration of printing paper for security according to a specific exemplary embodiment of the present invention.

As shown in FIG. 1, printing paper for security according to an exemplary embodiment of the present invention includes a first raw paper sheet 10 and a second raw paper sheet 20. The first raw paper sheet 10 and the second raw paper sheet 20 have the same composition as general printing paper.

For example, the first raw paper sheet 10 and the second raw paper sheet 20 may be produced by using a pulp slurry in which needle bleached kraft pulp (NBKP) and leaf bleached kraft pulp (LBKP) are mixed with each other, and titanium dioxide TiO2 is added in a maximum amount of 20% on the basis of the dried pulp. However, the composition of the first raw paper sheet 10 and the second raw paper sheet 20 as described above may be varied according to the use of the printing paper and the quality.

In addition, the first raw paper sheet 10 and the second raw paper sheet 20 may be produced by using a general production method of printing paper that includes dehydrating, compressing, and drying the pulp slurry having the above composition in a machine finish.

According to an exemplary embodiment of the present invention, since the first raw paper sheet 10 and the second raw paper sheet 20 are laminated to form printing paper, the weights of the first raw paper sheet 10 and the second raw paper sheet 20 are controlled while the total weight of the two papers is in the weight range of a general printing paper.

That is, since the weight of the general printing paper is in the range of 70 gsm to 90 gsm, according to an exemplary embodiment of the present invention, the total of the weights of the first raw paper sheet 10 and the second raw paper sheet 20 is in the range of 70 gsm to 90 gsm.

At this time, when the printing paper is used as printing paper both sides of which can be printed, it is preferable that the qualities of both sides of the printing paper are the same. Thus, the same type of raw paper sheet having the weights of 35 gsm to 40 gsm may be used as the first raw paper sheet 10 and the second raw paper sheet 20.

Meanwhile, the weights of the first raw paper sheet 10 and the second raw paper sheet 20 may be controlled so that the total of weights of the first raw paper sheet 10 and the second raw paper sheet 20 is 100 gsm or more, but in an exemplary embodiment of the present invention, when the printing paper is used to perform the printing operation in a general printer, in order to prevent a paper jam, the total of the weights of the first raw paper sheet 10 and the second raw paper sheet 20 are 70 gsm to 90 gsm.

In addition, between the first raw paper sheet 10 and the second raw paper sheet 20, the tag for detection 30 that includes the magnetic material is provided. The tag for detection 30 may comprise an amorphous soft magnetic alloy. This has the same composition as the amorphous label that is a sensitive tape, a magnetic tape, a tattle tape, a tag for detection, and a paper tag attached to a document in order to prevent outflow of the document.

Particularly, in an exemplary embodiment of the present invention, a thin line label that is produced by using a method of making a thin and slim cobalt-based amorphous metal alloy and heat treating the alloy is used as the tag for detection 30.

At this time, the thin line label has a length of 3 cm or more, a thickness of 0.01 mm, and a width of 0.65 mm, and is thin and slim to easily produce the printing paper including the same. However, when the length and the width of the tag for detection 30 comprising the thin line label is long and wider, the possibility of sensing the tag for detection 30 by the sensing means is high. Thus, the size of the thin line label may be differentially selected according to the use or the quality.

In addition, the tag for detection 30 may be provided at any position of the attachment side to which the first raw paper sheet 10 and the second raw paper sheet 20 are attached. However, in order to prevent the outflow of the tag for detection 30 by damaging the printing paper, it may be positioned at the center of the attachment side of the first raw paper sheet 10 and the second raw paper sheet 20.

In addition, the number and the arrangement of tags for detection 30 provided may be differentially selected according to the use or the quality of the printing paper, and preferably the optimum number and arrangement are required to increase the sensing possibility of the sensing means and reduce the production cost.

Particularly, when two or more of the tags for detection 30 are provided, each of the tags for detection 30 is vertical arranged, the sensing possibility can be efficiently increased.

According to an exemplary embodiment of the present invention, the tag for detection 30 is designed to be detected by an electromagnetic (EM) type of sensing means. That is, if the soft magnetic material such as the tag for detection 30 approaches an AC magnetic field generated by the sensing means, a change occurs in the AC magnetic field and the spectrum of the high frequency wave generated by the change is detected to ring a buzzer.

The sensing means generally includes a transmission coil that generates the AC magnetic field, a receiving coil that senses a change in the AC magnetic field generated by the transmission coil, and an electronic system that controls the AC magnetic field generated in the transmission coil and treats the signal received by the receiving coil. Since the sensing system is easily known by a person of ordinary skill in the art to which the present invention belongs, a detailed description thereof will be omitted.

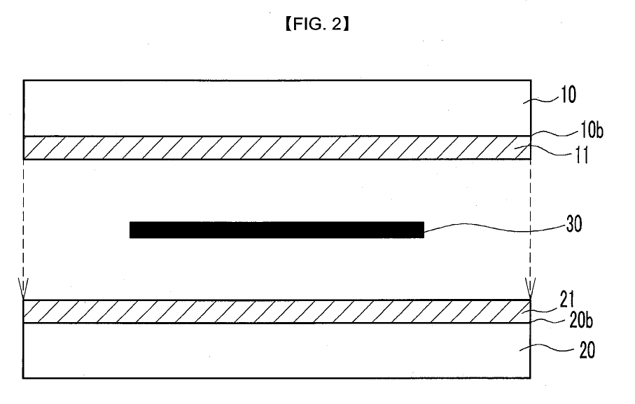

FIG. 2 is a cross-sectional view of printing paper for security according to the first exemplary embodiment of the present invention.

Referring to FIG. 2, hiding layers 11 and 21 are respectively formed on an attachment side 10b of the first raw paper sheet 10 and an attachment side 20b of the second raw paper sheet 20. According to an exemplary embodiment of the present invention, the hiding layers 11 and 21 are formed on the attachment side 10b of the first raw paper sheet and the attachment side 20b of the second raw paper sheet by black ink printing, and are used to improve opaqueness of the printing paper to increase the concealment of the tag for detection 30.

The tag for detection 30 is attached by the attachment means between the first raw paper sheet and the second raw paper sheet on which the hiding layers are formed. As the attachment means, in order to attach the raw paper sheet, various adhesives such as a generally-used adhesive, that is, starch or a derivative of starch, an acryl-based resin, a polyvinyl alcohol-based resin, or soda silicon may be used.

According to the first exemplary embodiment of the present invention as described above, since the tag for detection 30 that includes the magnetic material is formed between the hiding layer 11 and the hiding layer 21 to not allow the tag to be seen from the outside of the printing paper, intentional damage to the tag for detection can be prevented. Thus, the security can be increased.

In the first exemplary embodiment of the present invention, the two hiding layers 11 and 21 are respectively formed on the raw paper sheets 10 and 20 and the tags, but only one hiding layer may be formed between a single raw paper sheet and a tag. In this case, if another raw paper sheet is produced by using an opaque paper, intentional damage to the tag for detection can be prevented.

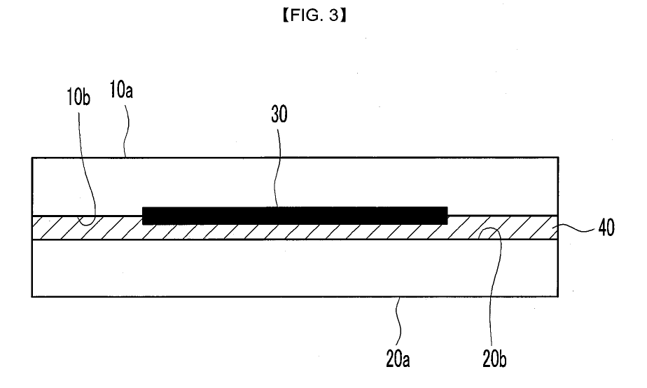

FIG. 3 is a cross-sectional view of printing paper for security according to the second exemplary embodiment of the present invention.

According to the second exemplary embodiment of the present invention that is shown in FIG. 3, in order to improve the concealment force of the printing paper, a metal thin film 40 is formed between the attachment side 10b of the first raw paper sheet 10 and the attachment side 20b of the second raw paper sheet 20.

Here, as a method of forming the metal thin film 40 between the attachment side 10b of the first raw paper sheet 10 and the attachment side 20b of the second raw paper sheet 20, the following various methods may be used.

First, the formed metal thin film may be attached between the attachment side 10b of the first raw paper sheet 10 and the attachment side 20b of the second raw paper sheet 20 by using the attachment means.

Alternatively, metal is vacuum-deposited on the attachment side 10b of the first raw paper sheet 10 or the attachment side 20b of the second raw paper sheet 20 to form the metal thin film 40.

Here, the vacuum deposition means a process in which the raw paper and the metal particles attached to the surface thereof are put into a vessel under a high vacuum state, and heated by a heater to vaporize the metal particles to condense metal particles on the surface of the cold raw paper and attach them thereto. By this process, a thinner metal thin film can be formed as compared to the method in which the formed metal thin film is attached between the raw paper sheets.

In addition, a metal that is vacuum deposited to a transfer film may be transferred to the attachment side 10b of the first raw paper sheet 10 or the attachment side 20b of the second raw paper sheet 20 to form the metal thin film 40.

Here, the transferring means a method in which the metal that is to be transferred to the raw paper is vacuum deposited on the transfer film, and the metal deposited on the transfer film is moved to the raw paper to obtain the effect in which the metal is finally deposited on the raw paper.

By this method, the yield of the production process can be increased as compared to the direct vacuum deposition method of the metal on the raw paper.

In addition, according to the second exemplary embodiment of the present invention, instead of separately forming the metal thin film on the raw paper, the raw paper that includes the metal that is vacuum deposited on a side thereof may be the first raw paper sheet 10 or the second raw paper sheet 20, or the raw paper in which the metal vacuum deposited on the transfer film is transferred to a side thereof may be either one of the first raw paper sheet 10 and the second raw paper sheet 20 to obtain the same effect. At this time, when the side on which the metal is vacuum deposited or the side to which the metal is transferred is used as the attachment side, as shown in FIG. 3, a printing paper of which both sides can be printed can be obtained.

According to the first exemplary embodiment and the second exemplary embodiment as described above, the concealment force of the tag for detection can be improved through the hiding layer or the metal thin film. However, since the opaque layer such as the hiding layer or the metal thin film is seen from the outside of the printing paper, there is a drawback in that the printing paper is totally dark.

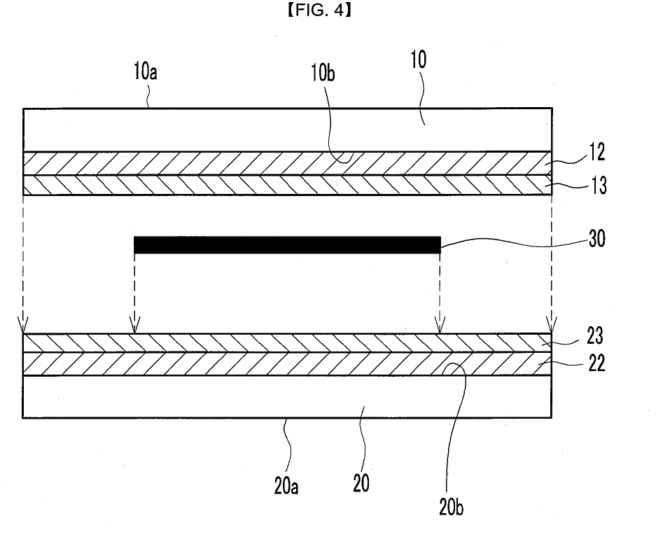

FIG. 4 is a cross-sectional view of printing paper for security according to the third exemplary embodiment of the present invention.

Referring to FIG. 4, a white printing layer 12 and a black printing layer 13 are sequentially formed on the first raw paper sheet 10.

The white printing layer 12 is formed on the attachment side 10b of the first raw paper sheet of FIGS. 1 to 4 by white ink printing. In addition, the black printing layer 13 is formed by the black ink printing of FIG. 1 after the white printing layer 12b is printed and then dried.

The black printing layer 13 is formed to improve the opaqueness of the printing paper to increase the concealment of the tag for detection 30.

In addition, the white printing layer 12 is formed to prevent the phenomenon in which the black printing layer 13 is shown from the outside 10a of the first raw paper sheet and improve the flatness of the printing paper.

The white ink for forming the white printing layer 12 may be a white gravure ink. In addition, the white ink for forming the white printing layer 12 may be any white ink including titanium dioxide, and in this case, the blocking effect with respect to the permeation of light can be increased by the titanium dioxide. Here, the concentration or the ratio of titanium dioxide is variable.

The white ink for forming the white printing layer 12 may be any white ink that includes a binder, a pigment, a dispersing agent, and a solvent. The binder functions to fix the pigment in the printing ink to the raw paper side and may include an acryl resin. In addition, the pigment is a white coloring agent and may be titanium dioxide, talc, white clay, and the like. The dispersing agent is used as an agent for uniformly dispersing the pigment, and the solvent comprises a component functioning to dissolve the solute to form a solution.

The white ink may further include a viscosity increasing agent, the viscosity increasing agent functions to increase the viscosity of the ink, and the white ink may be controlled so as to have a viscosity similar to white gravure ink.

Meanwhile, a white printing layer 22 and a black printing layer 23 are sequentially formed on the attachment side 20b of the second raw paper sheet 20. The white printing layer 22 is formed by printing the white ink on the attachment side 20b of the second raw paper sheet shown in FIGS. 1 to 4. In addition, the black printing layer 13 is formed by the black ink printing of FIG. 1 after the white printing layer 12b is printed and dried.

At this time, the black printing layer 23 is formed to improve the opaqueness of the printing paper to increase the concealment of the tag for detection 30.

The white printing layer 22 is formed to prevent the phenomenon in which the black printing layer 23 is shown from the outside 20a of the second raw paper sheet and improve the flatness of the printing paper.

Like the white ink for forming the white printing layer 12, the white ink for forming the white printing layer 22 may be a white gravure ink, a white ink including titanium dioxide, and the like.

As described above, between the first raw paper sheet 10 on which the white printing layer 12 and the black printing layer 13 are sequentially formed and the second raw paper sheet 20 on which the white printing layer 22 and the black printing layer 23 are sequentially formed, the tags for detection 30 are appropriately arranged, and the first raw paper sheet 10 and the second raw paper sheet 20 are laminated to produce the printing paper for security according to the third exemplary embodiment of the present invention.

According to the third exemplary embodiment of the present invention, since the tag for detection 30 including the magnetic material is formed between the black printing layer 13 and the black printing layer 23, the tag is not shown from the outside of the printing paper. Thus, the security is high. In addition, when the tag is shown from the outside of the printing paper, since the white printing layer 12 and the white printing layer 22 are respectively formed on the black printing layer 13 and the black printing layer 23, the black printing layer 13 and the black printing layer 23 are not shown from the outside and the flatness is increased.

Further, according to the third exemplary embodiment of the present invention, the paint may be painted on at least one of the outer side 10a of the first raw paper sheet and the outer side 20a of the second raw paper sheet of the printing paper, which are laminated to each other.

Here, the paint may be formed of at least one of titanium dioxide, white clay, and talc. As described above, the painting of the paint on the printing paper is performed in order to improve the whiteness of the printing paper and increase the concealment force of the tag for detection 30.

In the third exemplary embodiment of the present invention, two black printing layers and two white printing layers are respectively formed between the raw paper sheets 10 and 20 and the tags, but only the black printing layer and the white printing layer may be formed between one raw paper sheet and the tag.

Next, a method of producing the printing paper according to an exemplary embodiment of the present invention will be described with reference to the drawings.

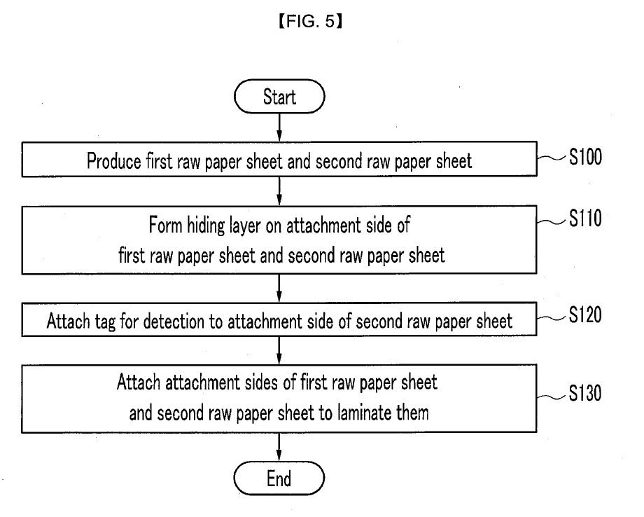

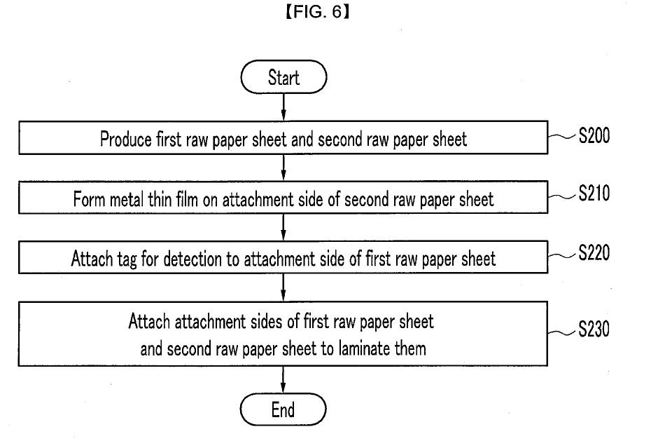

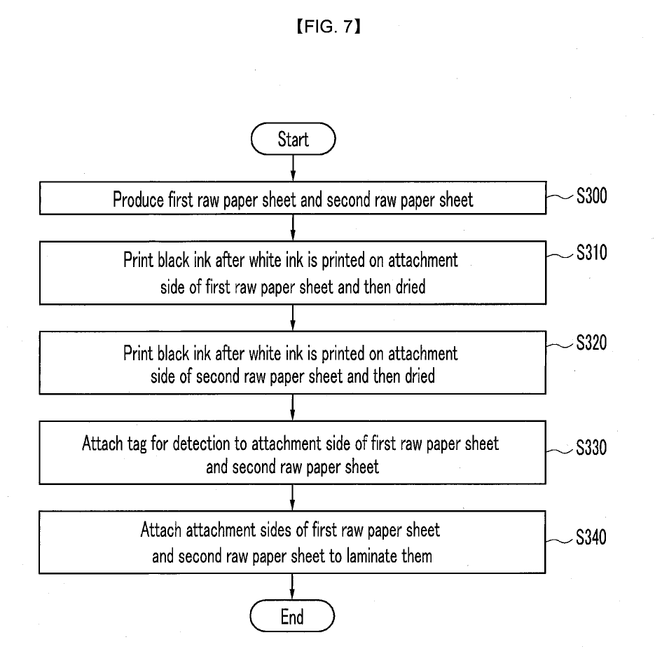

FIG. 5 is a flowchart that illustrates a method of producing the printing paper for security according to the first exemplary embodiment of the present invention, FIG. 6 is a flowchart that illustrates a method of producing the printing paper for security according to the second exemplary embodiment of the present invention, and FIG. 7 is a flowchart that illustrates a method of producing the printing paper for security according to the third exemplary embodiment of the present invention.

Referring to FIG. 5, a method of producing the printing paper for security according to the first exemplary embodiment of the present invention will be described.

As shown in FIG. 5, according to the first exemplary embodiment of the present invention, first, the first raw paper sheet 10 and the second raw paper sheet 20 are produced. (S100)

In addition, the hiding layer is formed on the produced first raw paper sheet 10 and second raw paper sheet 10. The hiding layer is formed by the black ink printing on the attachment side 10b of the first raw paper sheet and the attachment side 20b of the second raw paper sheet.

Then, the tag for detection 30 is attached to the attachment side 10b of the first raw paper sheet or the attachment side 20b of the second raw paper sheet.

The attachment side 10b of the first raw paper sheet and the attachment side 20b of the second raw paper sheet are then attached to each other to be laminated. As described above, if the printing paper is produced according to the first exemplary embodiment of the present invention, incidental steps such as the cutting, packing, and the like thereof are performed.

Next, referring to FIG. 6, a method of producing printing paper for security according to the second exemplary embodiment of the present invention will be described.

As shown in FIG. 6, according to the second exemplary embodiment of the present invention, first, the first raw paper sheet 10 and the second raw paper sheet 20 are produced. (S200)

The metal thin film is formed on either one of the produced first raw paper sheet 10 and second raw paper sheet 10. In step S210, for convenience of understanding, the attachment of the metal thin film to the attachment side 20b of the second raw paper sheet 20 is given as an example.

Then, the tag for detection 30 is attached to the attachment side 10b of the first raw paper sheet.

The attachment side 10b of the first raw paper sheet to which the tag for detection 30 is attached and the attachment side 20b of the second raw paper sheet to which the metal thin film 40 is attached are then attached to each other to be laminated. As described above, if the printing paper is produced according to the second exemplary embodiment of the present invention, incidental steps such as the cutting, packing, and the like thereof are performed.

According to the second exemplary embodiment of the present invention, in S210, the step is performed so that the opaqueness of the produced printing paper is improved so as to not expose the existence and the position of the tag for detection 30. In addition, in S210, instead of attaching the metal thin film to the attachment side 20b of the second raw paper sheet, a method of vacuum depositing the metal to the attachment side 10b of the first raw paper sheet (or the attachment side 20b of the second raw paper sheet) or a method of transferring the metal that is vacuum deposited on the transfer film to the attachment side 10b of the first raw paper sheet (or the attachment side 20b of the second raw paper sheet) may be performed to realize the step.

In addition, when the first raw paper sheet 10 or the second raw paper sheet 20 is produced to form the raw paper sheet to which the metal is vacuum deposited on a side thereof or the raw paper sheet on which the vacuum deposited metal is transferred on a side thereof in S100, step S210 is unnecessary.

Further, instead of forming the metal thin film 40 in S210, some processes such as carbon coating to the attachment side 10b of the first raw paper sheet or the attachment side 20b of the second raw paper sheet or total printing using ink having a color of low brightness may be performed.

That is, in S210, instead of forming the metal on the attachment side 10b of the first raw paper sheet or the attachment side 20b of the second raw paper sheet, the opaqueness is improved by carbon coating and the like, and the tag for detection 30 is attached thereto and laminated therein to produce the printing paper.

Next, referring to FIG. 7, a method of producing the printing paper for security according to the third exemplary embodiment of the present invention will be described.

As shown in FIG. 7, according to the third exemplary embodiment of the present invention, first, the first raw paper sheet 10 and the second raw paper sheet 20 are produced.

Then, the white ink is printed on the attachment side of the first raw paper sheet 10 and the black ink is printed. (S310)

To describe step S310 in more detail, specifically, the white ink is applied in an appropriate amount at an angle of 1 to 4 degrees through the printing and drying processes, and is printed on the attachment side 10b of the first raw paper sheet. Accordingly, the flatness of the printed side is improved and the black ink as described later on the outer side 10a of the first raw paper sheet can be prevented from being seen from the outside.

Then, the black ink is printed on the attachment side 10b of the first raw paper sheet on which the white ink is printed at an angle of 1 degree. Thereby, the concealment of the tag for detection 30 that will be attached between the first raw paper sheet 10 and the second raw paper sheet 20 can be improved.

Then, the white ink is printed on the attachment side of the first raw paper sheet 20 and the black ink is printed (S320).

In step S320, the white ink that is printed on the second raw paper sheet 20 may be of the same type or composition as the white ink that is printed on the first raw paper sheet.

In addition, by steps S310 and S320, the attachment process of the tag for detection 30 to either one of the attachment sides 10b and 20b of the first raw paper sheet 10 and the second raw paper sheet 20 after the printing process is finished may be performed (S330).

If the attachment of the tag for detection 30 is finished in step S330, the first raw paper sheet 10 and the second raw paper sheet 20 are laminated to finish the production of the printing paper (S340).

At this time, attachment means are used to perform the lamination. The attachment means include various adhesives such as a generally-used adhesive, that is, a starch or starch derivative, an acryl-based resin, a polyvinyl alcohol-based resin, or sodium silicate, in order to perform the attachment of the paper raw paper.

In addition, after the lamination process as described above, a paint that includes at least one component of titanium dioxide, white clay, and talc may be painted on at least one of the outer side 10a of the first raw paper sheet and the outer side 20a of the second raw paper sheet to reduce the light permeability of the printing paper.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. Printing paper for security, comprising:
a first raw paper sheet and a second raw paper sheet;
a first hiding layer that is formed on a side of the first raw paper sheet;
a second hiding layer that is formed on a side of the second raw paper sheet; and
at least one tag for detection that is formed between the first hiding layer and the second hiding layer and includes a magnetic material.

2. Printing paper for security, comprising:
a first raw paper sheet and a second raw paper sheet;
a metal thin film that is formed on a side of the second raw paper sheet; and
at least one tag for detection that is formed between the metal thin film and a side of the first raw paper sheet and includes a magnetic material.

3. Printing paper for security comprising:
a first raw paper sheet and a second raw paper sheet;
a first printing layer and a second printing layer that are sequentially printed on a side of the first raw paper sheet;
a third printing layer and a fourth printing layer that are sequentially printed on a side of the second raw paper sheet; and
at least one tag for detection that is formed between the second printing layer and the fourth printing layer and includes a magnetic material.

4. The printing paper for security of claim 1, wherein the tag for detection includes an amorphous soft magnetic alloy.

5. The printing paper for security of claim 1, wherein the first hiding layer and the second hiding layer are each formed on a side of the first raw paper sheet and on a side of the second raw paper sheet by black ink printing.

6. The printing paper for security of claim 2, wherein the metal thin film is produced by depositing a metal under vacuum or transferring the metal to a side of the first raw paper sheet.

7. The printing paper for security of claim 3, wherein the first printing layer and the third printing layer are white printing layers, and the second printing layer and the fourth printing layer are black printing layers.

8. The printing paper for security of claim 7, wherein titanium dioxide is added to the white ink

9. The printing paper for security of claim 7, wherein the white ink includes a binder, a pigment, a dispersing agent, and a solvent.

10. The printing paper for security of claim 3, wherein a paint is painted on at least one of another side of the first raw paper sheet and another side of the second raw paper sheet.

11. The printing paper for security of claim 10, wherein the paint includes at least one of titanium dioxide, white clay, and talc.

12. A method of producing printing paper for security, the method comprising:
forming a first hiding layer on a side of a first raw paper sheet;
forming a second hiding layer on a side of a second raw paper sheet; and
laminating the first raw paper sheet and the second raw paper sheet while a tag for detection including a magnetic material is provided between the first hiding layer and the second hiding layer.

13. A method of producing printing paper for security, the method comprising:
attaching a tag for detection including a magnetic material on a side of a first raw paper sheet;
forming a metal thin film on a side of a second raw paper sheet; and
laminating a side of the first raw paper sheet and a side of the second raw paper sheet so that the tag for detection and the metal thin film are in contact.

14. A method of producing printing paper for security, the method comprising:
sequentially printing a first printing layer and a second printing layer on a side of a first raw paper sheet;
sequentially printing a third printing layer and a fourth printing layer on a side of a second raw paper sheet; and
laminating the first raw paper sheet and the second raw paper sheet while at least one tag for detection including a magnetic material is provided between the second printing layer and the fourth printing layer.

15. The method of producing printing paper for security of claim 12, wherein the first hiding layer and the second hiding layer are each formed on a side of the first raw paper sheet and on a side of the second raw paper sheet by black ink printing.

16. The method of producing printing paper for security of claim 14, wherein the first printing layer and the third printing layer are white printing layers, and the second printing layer and the fourth printing layer are black printing layers.

17. The method of producing printing paper for security of claim 13, wherein the forming of the metal thin film is performed by attaching the metal thin film to a side of the second raw paper sheet or depositing the metal under a vacuum.

18. The method of producing printing paper for security of claim 13, wherein the forming of the metal thin film includes depositing the metal on a transfer film under a vacuum and transferring the metal deposited under a vacuum to a side of the second raw paper sheet.

19. Printing paper for security, comprising: a first raw paper sheet and a second raw paper sheet;
at least one tag for detection that is formed between the first raw paper sheet and the second raw paper sheet and includes a magnetic material; and
a hiding layer that is formed between the first raw paper sheet and the tag for detection.

20. The printing paper for security of claim 19, wherein the hiding layer is formed on a side of the first raw paper sheet by black ink printing.

21. Printing paper for security, comprising:
a first raw paper sheet and a second raw paper sheet;
at least one tag for detection that is formed between the first raw paper sheet and the second raw paper sheet and includes a magnetic material; and
a first printing layer and a second printing layer that are sequentially printed between the first raw paper sheet and the tag for detection.

22. The printing paper for security of claim 21, wherein the first printing layer is a white printing layer, and the second printing layer is a black printing layer.

23. The printing paper for security of claim 2, wherein the tag for detection includes an amorphous soft magnetic alloy.

24. The printing paper for security of claim 3, wherein the tag for detection includes an amorphous soft magnetic alloy.
